(19) United States
(12) Patent Application Publication
(10) Pub. No.: US 2025/0214212 A1
(43) Pub. Date: Jul. 3, 2025

(54) NAIL GUN AND RESTRICTION DEVICE THEREOF

(71) Applicant: BASSO INDUSTRY CORP., Taichung (TW)

(72) Inventors: Liang-Chi HUNG, Taichung (TW); Hung-Da Chen, Taichung (TW)

(73) Assignee: BASSO INDUSTRY CORP., Taichung (TW)

(21) Appl. No.: 19/008,399

(22) Filed: Jan. 2, 2025

(30) Foreign Application Priority Data
Jan. 3, 2024 (TW) 113100275

(51) Int. Cl. B25C 1/00

(52) U.S. Cl. CPC B25C 1/005

(57) ABSTRACT

A restriction device is adapted to be mounted to a nail gun that has a barrel device and that accommodates a plurality of nails. Each nail has a nail head and a nail shaft. The restriction device includes a restriction member that has first and second obstruction portions. The restriction member is adapted to be movable between an obstruction position and a release position. When the restriction member is in the obstruction position, the first obstruction portion is adapted to be slotted between the nail shaft of one of the plurality of nails and the nail shaft of an adjacent one of the plurality of nails, and the second obstruction portion is adapted to abut against the nail head of the one of the plurality of nails or to abut the nail shaft of the adjacent one of the plurality of nails against the barrel device.

### CROSS-REFERENCE TO RELATED APPLICATION

This application claims priority to Taiwanese Invention Patent Application No. 113100275, filed on Jan. 3, 2024, the entire disclosure of which is incorporated by reference herein.

### FIELD

The disclosure relates to a nail gun, and more particularly to a nail gun and a restriction device thereof for restricting positions of a plurality of nails.

### BACKGROUND

A conventional power tool device as disclosed in Taiwanese Invention Patent No. I426984 is adapted to accommodate a plurality of fasteners, and includes first and second nail stoppers for blocking the fasteners from moving toward a magazine, and a movable nail stopper for preventing the fasteners from moving in a direction opposite to a nail-striking direction. Hence, each of the fasteners can be stably disposed in a drive channel of the conventional power tool device. Furthermore, the fasteners may be of two different lengths.

However, since the first and second nail stoppers and the movable nail stopper all move independently, and since the first and second nail stoppers move in a direction different from a moving direction of the movable nail stopper, the structure of the conventional power tool device is complicated, and thus it takes a lot of time and much manpower to assemble or disassemble the conventional power tool device.

### SUMMARY

Therefore, an object of the disclosure is to provide a restriction device that can alleviate at least one of the drawbacks of the prior art.

According to the disclosure, the restriction device is adapted to be mounted to a nail gun. The nail gun includes a barrel device and a magazine unit that is connected to the barrel device. The barrel device has a nail channel that extends in an axial direction along an axis, and a muzzle that is connected to the nail channel. The magazine unit accommodates a plurality of nails that are strung together, and is operable for moving the plurality of nails one by one into the nail channel in a feed direction transverse to the axial direction. Each of the plurality of nails includes a nail head and a nail shaft that extends from the nail head. The restriction device includes at least one restriction member that extends in the axial direction, that is adapted to be mounted to the barrel device and proximate to the nail channel, and that has first and second obstruction portions extending in an actuation direction perpendicular to the axial direction. The first and second obstruction portions are spaced apart from each other in the axial direction. The first obstruction portion is adapted to be disposed proximate to the muzzle. The at in least one restriction member is adapted to be movable relative to the barrel device along a plane extending in the axial direction and the actuation direction between an obstruction position and a release position. When the at least one restriction member is in the obstruction position, the first and second obstruction portions are adapted to be proximate to the axis, the first obstruction portion is adapted to be slotted between the nail shaft of one of the plurality of nails and the nail shaft of an adjacent one of the plurality of nails that is adjacent to the one of the plurality of nails, and the second obstruction portion is adapted to abut against the nail head of the one of the plurality of nails or to abut the nail shaft of the one of the plurality of nails against the barrel device. When the at least one restriction member is in the release position, the first and second obstruction portions are distanced away from the axis to allow movement of the plurality of nails in the feed direction. The first obstruction portion is adapted to be pushed by the plurality of nails during movement of the plurality of nails in the feed direction to thereby move the at least one restriction member from the obstruction position to the release position.

Another object of the disclosure is to provide a nail gun that includes the abovementioned restriction device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a side view illustrating an embodiment of a nail gun according to the disclosure.

FIG. 2 is a fragmentary exploded perspective view of the embodiment.

FIG. 3 is a perspective view of a restriction member of the embodiment.

FIG. 4 is a fragmentary sectional view taken along line IV-IV in FIG. 1, illustrating the restriction member in an obstruction position and the nail gun accommodating a plurality of short nails.

FIG. 5 is a fragmentary sectional view of the embodiment.

FIG. 6 is a fragmentary sectional view taken along line VI-VI in FIG. 5.

FIG. 7 is a fragmentary sectional view similar to FIG. 5, but illustrates one of the short nails pushing against the restriction member.

FIG. 8 is a fragmentary sectional view taken along line VIII-VIII in FIG. 7.

FIG. 9 is a fragmentary sectional view of the embodiment, illustrating the restriction member in a release position and the nail gun accommodating a plurality of short nails.

FIG. 10 is a fragmentary sectional view similar to FIG. 5, but illustrates the nail gun accommodating a plurality of long nails.

FIG. 11 is a fragmentary sectional view similar to FIG. 9, but illustrates the restriction member in the release position and the nail gun accommodating the plurality of long nails.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

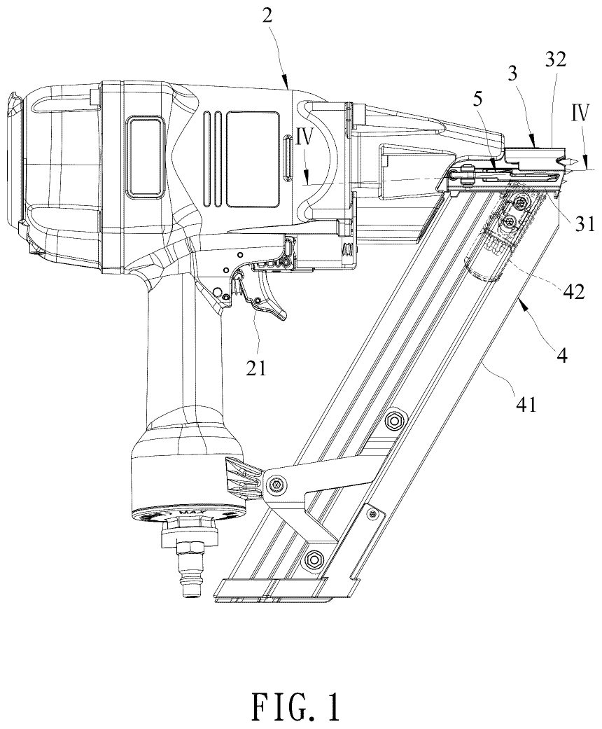

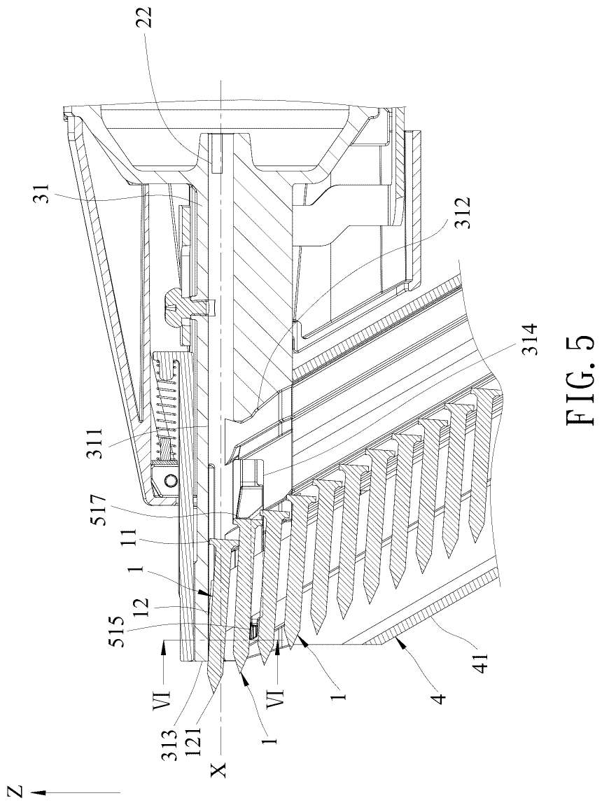

Referring to FIGS. 1 to 4, an embodiment of a nail gun according to the disclosure is adapted for firing a plurality of nails 1 (see FIG. 5). The nails 1 are strung together, and each of the nails 1 includes a nail head 11 and a nail shaft 12 that extends from the nail head 11. The nail shaft 12 has a nail point 121 opposite to the nail head 11. In this embodiment, the nails 1 may be short nails that are 1.5 inches long, or long nails that are 2.5 inches long.

The nail gun includes a nail gun body 2, a barrel device 3, a magazine unit 4, and a restriction device 5.

The nail gun body 2 includes a trigger unit 21 operable for triggering a nail driver member 22 (see FIG. 5) to fire the nails 1.

Referring to FIGS. 1 to 5, the barrel device 3 is connected to the nail gun body 2, and has a barrel 31 that is connected to the nail gun body 2 and the magazine unit 4 and that defines a nail channel 311, and a sleeve 32 that is sleeved on the barrel 31. The nail channel 311 extends in an axial direction along an axis (X), and is adapted to accommodate one of the nails 1. The nail driver member 22 is disposed in the nail channel 311. A length of the sleeve 32 in the axial direction is not greater than a length of the barrel 31 in the axial direction. The barrel 31 has a passage 312 that spatially communicates with the nail channel 311, a muzzle 313 that is formed on an end of the barrel 31 and that is connected to the nail channel 311, and an opening 314 that extends in the axial direction and spatially communicates with the nail channel 311. Specifically, the passage 312 spatially communicates with the nail channel 311, the opening 314, and the magazine unit 4 such that each of the plurality of nails 1 enters the nail channel 311 from the magazine unit 4 through the passage 312.

Referring to FIGS. 1 to 5, the magazine unit 4 includes a nail cartridge 41 and a nail feeder unit 42. The nail cartridge 41 is connected to the barrel device 3, and is adapted to accommodate the nails 1. The nail feeder unit 42 is mounted in the nail cartridge 41, and is operable for moving the nails 1 one by one into the nail channel 311 through the passage 312 in a feed direction (Z) transverse to the axial direction. It should be noted that, the nails 1 are inclined, such that, for each of the nails 1, the nail point 121 is higher than the nail head 11 in the feed direction (Z).

It should be noted that, in this embodiment, the nail channel 311 is adapted to accommodate a first one of the nails 1 in a manner where the nail point 121 of the first one of the nails 1 extends outwardly of the nail channel 311 through the muzzle 313 so that the first one of the nails 1 may be aimed at an item to be nailed (not shown).

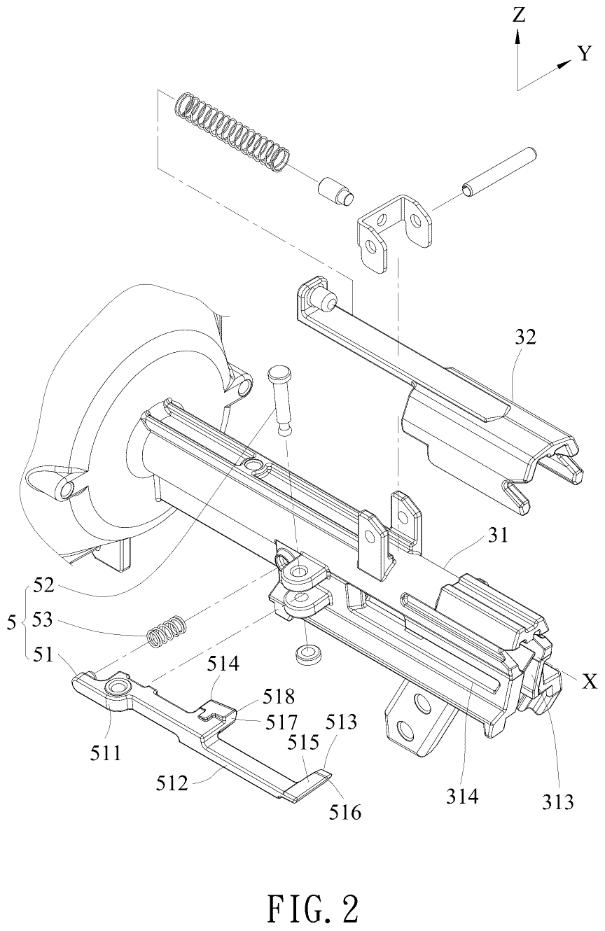

Referring to FIGS. 2 to 5, the restriction device 5 includes at least one restriction member 51, at least one fastener member 52, and at least one resilient member 53. In this embodiment, a number of the at least one restriction member 51, a number of the at least one fastener member 52, and a number of the at least one resilient member 53 are one.

The restriction member 51 extends in the axial direction, is mounted to the barrel 31 and proximate to the nail channel 311, and is movable relative to the barrel device 3 along a plane extending in the axial direction and an actuation direction (Y) perpendicular to the axial direction and the feed direction (Z). Specifically, the restriction member 51 has a pivot joint segment 511 that is pivotably mounted to the barrel 31, a pivot body segment 512 that extends from the pivot joint segment 511 and that is movable relative to the barrel 31, and first and second obstruction portions 513, 514 that extend from the pivot body segment 512 in the actuation direction (Y) through the opening 314, and that are disposed between the passage 312 and the nail channel 311.

The first obstruction portion 513 is disposed proximate to the muzzle 313, and is spaced apart from the second obstruction portion 514 in the axial direction. The first obstruction portion 513 has an obstruction surface 515 that is elongated in the actuation direction (Y), and a first inclined surface 516 that is adapted to be in sliding contact with the nails 1.

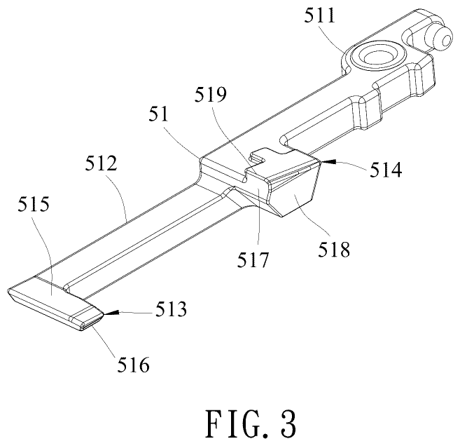

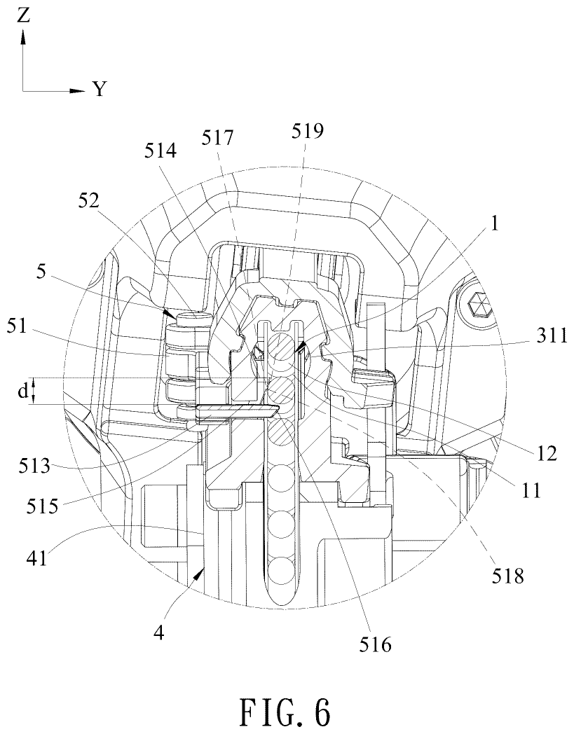

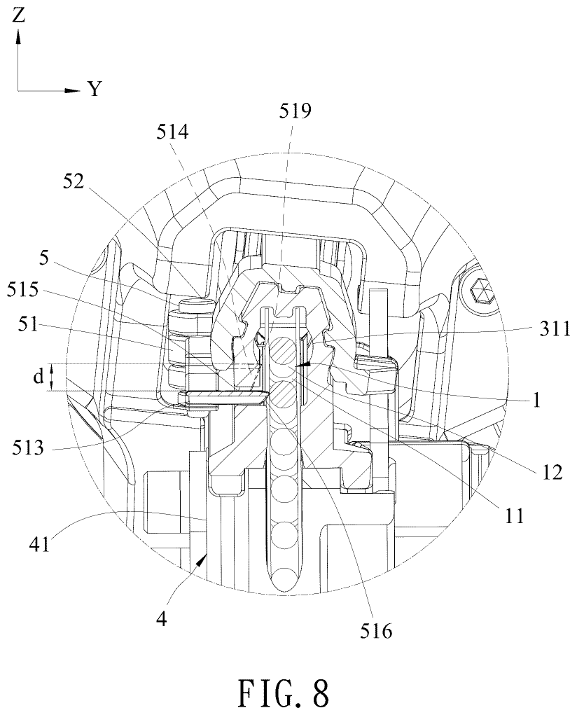

Referring to FIGS. 3 to 6, the second obstruction portion 514 has an abutment surface 517 facing the first obstruction portion 513 and extending into the nail channel 311, and a second inclined surface 518 adapted to be in sliding contact with the nails 1. The abutment surface 517 has an edge 519 that extends in the actuation direction (Y) and that is distanced from the obstruction surface 515 in the feed direction (Z) by a spacing distance (d) (see FIG. 8). Since the nails 1 are inclined, the spacing distance (d) ensures each of the nails 1 to firmly abut against the first obstruction portion 513 during movement into the nail channel 311. A first gap distance (t1) in the actuation direction (Y) between the first obstruction portion 513 and the axis (X) is smaller than a second gap distance (t2) in the actuation direction (Y) between the second obstruction portion 514 and the axis (X).

It should be noted that the abutment surface 517 partially extends into the nail channel 311, so there is a gap between the barrel 31 and the second obstruction portion 514, and the nail driver member 22 is able to pass through the gap to move along the axis (X). Hence, the nail driver member 22 is able to move smoothly in the nail channel 311.

The fastener member 52 extends through the pivot joint segment 511 and is connected to the barrel 31.

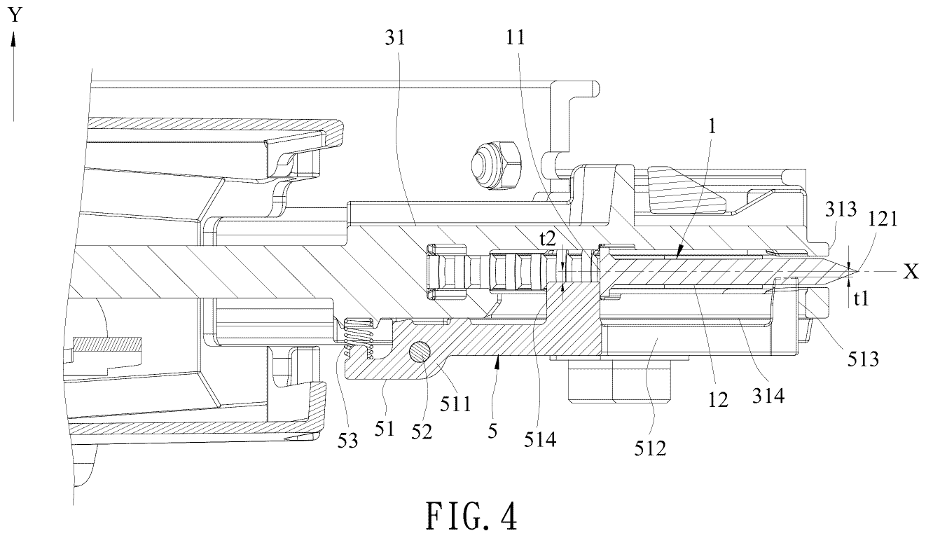

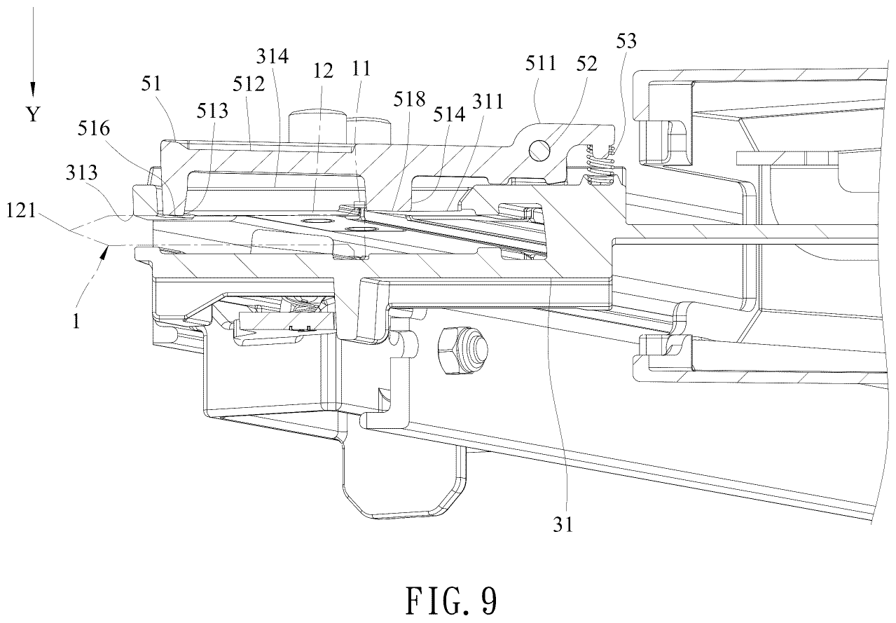

Referring to FIGS. 4 to 6 and FIG. 9, the restriction member 51 is pivotable about the fastener member 52 relative to the barrel 31 along the plane extending in the axial direction and the actuation direction (Y) between an obstruction position (see FIG. 4) and a release position (see FIG. 9). When the restriction member 51 is in the obstruction position, the first and second obstruction portions 513, 514 are proximate to the axis (X), the abutment surface 517 is spaced apart from the muzzle 313 along the axis (X), the first obstruction portion 513 is adapted to be slotted between the nail shaft 12 of one of the nails 1 and the nail shaft 12 of an adjacent one of the nails 1 that is adjacent to the one of the nails 1, and the second obstruction portion 514 is adapted to abut against the nail head 11 of the one of the nails 1 or to abut the nail shaft 12 of the one of the nails 1 against the barrel device 3. When the restriction member 51 is in the release position, the first and second obstruction portions 513, 514 are distanced away from the axis (X) to allow movement of the plurality of nails 1 in the feed direction (Z). The first obstruction portion 513 is adapted to be pushed by the nails 1 during movement of the nails 1 in the feed direction (Z) to thereby move the restriction member 51 from the obstruction position to the release position.

The resilient member 53 is mounted between the restriction member 51 and the barrel 31, and biases the restriction member 51 towards the obstruction position.

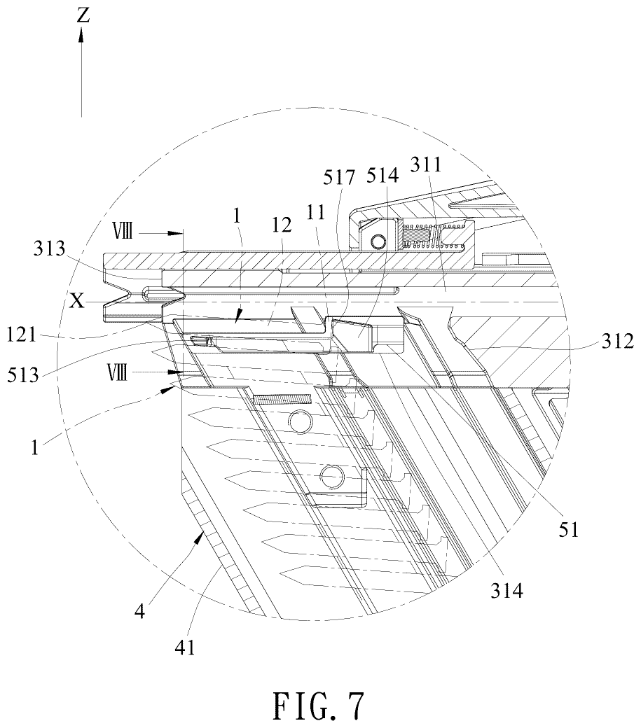

Referring to FIGS. 1 and 7 to 9, the nails 1 may be short nails. After the first one of the nails 1 is fired through the nail driver 22, the nail feeder unit 42 pushes the nails 1 to move in the feed direction (Z), and moves the nails 1 from the nail cartridge 41 into the passage 312 to enter the nail channel 311. Specifically, during movement of the nails 1, the one of the nails 1 (i.e., the nail 1 next to the first one of the nails 1) moves toward the nail channel 311, and the adjacent one of the nails 1 (i.e., the nail 1 next to the one of the nails 1) pushes against the first inclined surface 516 of the first obstruction portion 513 and overcomes a resilient force of the resilient member 53 to move the restriction member 51 from the obstruction position to the release position.

When the restriction member 51 is moved to the release position, the adjacent one of the nails 1 is allowed to move in the feed direction (Z) past the first obstruction portion 513, and moves in the passage 312 until the one of the nails 1 enters the nail channel 311.

After the adjacent one of the nails 1 moves past the first obstruction portion 513 and the one of the nails 1 enters the nail channel 311, the restriction member 51 is not pushed by any one of the nails 1 and is biased towards the obstruction position by the resilient force of the resilient member 53. Referring to FIGS. 4 to 6, at this time, the abutment surface 517 abuts against the nail head 11 of the one of the nails 1 to prevent the adjacent one of the nails 1 from moving in the axial direction. In addition, since the first obstruction portion 513 is slotted between the nail shafts 12 of the adjacent one of the nails 1 and the another one of the nails 1, and since the obstruction surface 515 abuts against the one of the nails 1, the adjacent one of the nails 1 is prevented from moving in a direction opposite to the feed direction (Z).

Since the nails 1 are strung together, each of the nails 1 restricts movement of the nail 1 that is next in line. When the restriction member 51 is in the obstruction position, the first and second obstruction portions 513, 514 block the nails 1 from moving in the axial direction and in the direction opposite to the feed direction (Z). Hence, the one of the nails 1 is stably disposed in the nail channel 311 so that the nail driver 22 can drive the one of the nails 1 in the nail channel 311 with more accuracy, thereby increasing nail-firing quality.

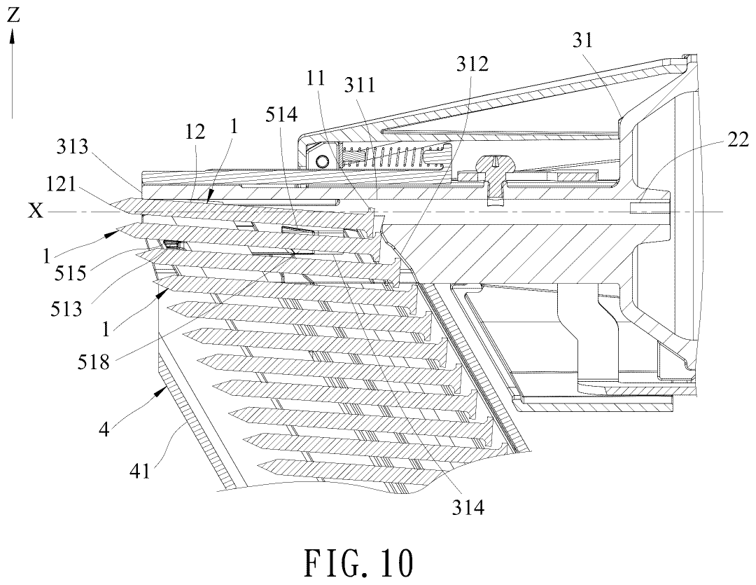

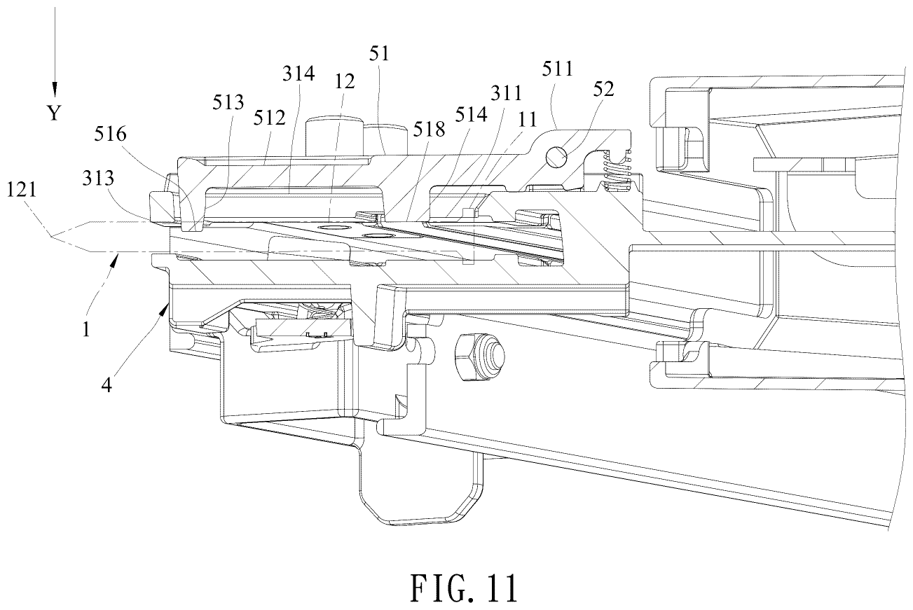

Referring to FIGS. 10 and 11, the nails 1 may alternatively be long nails. After the first one of the nails 1 is fired, the nail feeder unit 42 pushes the nails 1 to move in the feed direction (Z), and moves the nails 1 from the nail cartridge 41 into the passage 312 to enter the nail channel 311. Since the first gap distance (t1) is smaller than the second gap distance (t2), and since the nails 1 are inclined, the adjacent one of the nails 1 comes into contact with the first inclined surface 516 of the first obstruction member 513 first when the nails 1 are moved in the feed direction (Z). Specifically, during movement of the nails 1, the adjacent one of the nails 1 pushes against the first inclined surface 516 of the first obstruction member 513 to move the restriction member 51 from the obstruction position to the release position.

When the restriction member 51 is moved to the release position, the adjacent one of the nails 1 is allowed to move in the feed direction (Z) past the restriction member 51, and moves in the passage 312 until the one of the nails 1 enters the nail channel 311.

The adjacent one of the nails 1 moves past the second obstruction portion 514, and continuously abuts against the second inclined surface 518 of the second obstruction portion 514 so that the restriction member 51 is stably positioned in the release position. At this time, the nail head 11 of the one of the nails 1 in the nail channel 311 abuts against the barrel 31, so that the nails 1 are prevented from moving in the axial direction. Hence, by virtue of the nails 1 being strung together and being obstructed by the barrel 31, the nails 1 are prevented from moving in the axial direction.

It should be noted that a number of the restriction member 51 is not limited to one, in other variants of the embodiment, the number may be two or three. In a variant of the embodiment where the at least one restriction member 51 includes a plurality of restriction members 51, the restriction members 51 are spaced apart from each other in the feed direction (Z), and the first obstruction portion 513 of one of the restriction members 51 is spaced apart from the first obstruction portion 513 of an adjacent one of the restriction members 51 in the axial direction, and the second obstruction portion 514 of the one of the restriction members 51 is spaced apart from the second obstruction portion 514 of the adjacent one of the restriction members 51 in the axial direction. The number of the restriction members 51 affects the types of nails (nails of different types have different lengths) that can be used in the nail gun. More specifically, when the number of restriction members 51 included in the restriction device 5 differs, the number of different types of nails usable with the nail gun differs. For example, in an embodiment where there is only one restriction member 51, the nail gun is usable with nails of two different lengths; in another embodiment where there are two restriction members 51, the nail gun is usable with nails of three different lengths, and so forth. Since the number of the restriction members 51 affecting the number of different types of nail length usable in the nail gun is well known in the art, further description thereof will be omitted for the sake of brevity.

In conclusion, advantages of the nail gun are as follows. In comparison with the aforementioned conventional power tool device, since the first and second obstruction portions 513, 514 are part of the restriction member 51 (i.e., the first and second obstruction portions 513, 514 are part of the same component as opposed to being independent components), a structure of the nail gun is simpler, and an amount of time and manpower needed for assembling or disassembling the nail gun is decreased. Furthermore, by virtue of the configurations of the first and second obstruction portions 513, 514, and the barrel 31, the nail gun may accommodate nails of different lengths. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A restriction device adapted to be mounted to a nail gun, the nail gun including a barrel device and a magazine unit that is connected to the barrel device, the barrel device having a nail channel that extends in an axial direction along an axis, and a muzzle that is connected to the nail channel, the magazine unit accommodating a plurality of nails that are strung together and being operable for moving the plurality of nails one by one into the nail channel in a feed direction transverse to the axial direction, each of the plurality of nails including a nail head and a nail shaft that extends from the nail head, said restriction device comprising:
at least one restriction member that extends in the axial direction, that is adapted to be mounted to the barrel device and proximate to the nail channel, and that has a first obstruction portion and a second obstruction portion extending in an actuation direction perpendicular to the axial direction, said first obstruction portion and said second obstruction portion being spaced apart from each other in the axial direction, said first obstruction portion being adapted to be disposed proximate to the muzzle;
wherein said at least one restriction member is adapted to be movable relative to the barrel device along a plane extending in the axial direction and the actuation direction between an obstruction position and a release position;
wherein, when said at least one restriction member is in the obstruction position, said first obstruction portion and said second obstruction portion are adapted to be proximate to the axis, said first obstruction portion is adapted to be slotted between the nail shaft of one of the plurality of nails and the nail shaft of an adjacent one of the plurality of nails that is adjacent to the one of the plurality of nails, and said second obstruction portion is adapted to abut against the nail head of the one of the plurality of nails or to abut the nail shaft of the one of the plurality of nails against said barrel device;
wherein, when said at least one restriction member is in the release position, said first obstruction portion and said second obstruction portion are distanced away from the axis to allow movement of the plurality of nails in the feed direction; and
wherein said first obstruction portion is adapted to be pushed by the plurality of nails during movement of the plurality of nails in the feed direction to thereby move said at least one restriction member from the obstruction position to the release position.

2. The restriction device as claimed in claim 1, wherein said first obstruction portion has an obstruction surface elongated in the actuation direction, and adapted to abut against the one of the plurality of nails when said at least one restriction member is at the obstruction position for preventing the one of the plurality of nails from moving in a direction opposite to the feed direction, the feed direction being substantially perpendicular to the axial direction and the actuation direction.

3. The restriction device as claimed in claim 2, wherein said second obstruction portion has an abutment surface facing said first obstruction portion, and adapted to be spaced apart from the muzzle along the axis when said at least one restriction member is at the obstruction position.

4. The restriction device as claimed in claim 3, wherein said abutment surface has an edge extending in the actuation direction, said edge being distanced from said obstruction surface in the feed direction by a spacing distance.

5. The restriction device as claimed in claim 3, wherein:
said first obstruction portion further has a first inclined surface, said second obstruction portion further having a second inclined surface, said first inclined surface and said second inclined surface being adapted to be in sliding contact with the plurality of nails; and
a first gap distance in the actuation direction between said first obstruction portion and the axis is smaller than a second gap distance in the actuation direction between said second obstruction portion and the axis.

6. The restriction device as claimed in claim 1, wherein said at least one restriction member further has a pivot joint segment that is adapted to be pivotably mounted to the barrel device, and a pivot body segment that extends from said pivot joint segment, said first obstruction portion and said second obstruction portion extending from said pivot body segment.

7. The restriction device as claimed in claim 6, further comprising at least one fastener member, said least one fastener member extending through said pivot joint segment and adapted to be connected to the barrel device, such that said at least one restriction member is pivotable along the plane extending in the axial direction and the actuation direction between the obstruction position and the release position.

8. The restriction device as claimed in claim 1, further comprising at least one resilient member that is adapted to be mounted between said at least one restriction member and the barrel device, and that biases said at least one restriction member towards the obstruction position.

9. A nail gun adapted for firing a plurality of nails, the plurality of nails being strung together, each of the plurality of nails including a nail head and a nail shaft that extends from the nail head, said nail gun comprising:
a barrel device that has a nail channel extending in an axial direction along an axis, and a muzzle connected to said nail channel;
a magazine unit that is connected to said barrel device, that is adapted to accommodate the plurality of nails, and that is operable for moving the plurality of nails one by one into said nail channel in a feed direction transverse to the axial direction; and
said restriction device as claimed in claim 1 that is pivotably mounted to said barrel device.

10. The nail gun as claimed in claim 9, wherein:
said barrel device has a barrel that is connected to said magazine unit and that defines said nail channel, and a sleeve that is sleeved on said barrel;
said nail channel is adapted to accommodate one of the plurality of nails in a manner where the one of the plurality of nails extends outwardly of said nail channel through said muzzle; and
a length of said sleeve in the axial direction is not greater than a length of said barrel in the axial direction.

11. The nail gun as claimed in claim 10, wherein said barrel has an opening extending in the axial direction and spatially communicating with said nail channel, said first obstruction portion and said second obstruction portion of said at least one restriction member extending in the actuation direction through said opening.

12. The nail gun as claimed in claim 11, wherein:
said barrel further has a passage that spatially communicates with said nail channel, said opening, and said magazine unit such that each of the plurality of nails enters said nail channel from said magazine unit through said passage; and
said first obstruction portion and said second obstruction portion are disposed between said passage and said nail channel.
